(19) United States
(12) Patent Application Publication
(10) Pub. No.: US 2018/0118021 A1
(43) Pub. Date: May 3, 2018

(54) WHEEL GEAR

(71) Applicant: Deere & Company, Moline, IL (US)

(72) Inventor: JAVIER J. MOSCOSO, Getafe (ES)

(21) Appl. No.: 15/787,122

(22) Filed: Oct. 18, 2017

(30) Foreign Application Priority Data
Oct. 28, 2016 (DE) 102016221357.1

(51) Int. Cl. B60K 17/04

(52) U.S. Cl. CPC B60K 17/043; F16H 1/22

(57) ABSTRACT

A wheel gear for a drive wheel of an agricultural vehicle includes a gear housing, a drive gear mounted on the gear housing, an output gear mounted on the gear housing, a first-stage intermediate gear pair including a first first-stage intermediate gear and a second first-stage intermediate gear, and a second-stage intermediate gear pair comprising a first second-stage intermediate gear and a second second-stage intermediate gear. The first-stage intermediate gear pair is in engagement with the drive gear and the second intermediate gear pair is in engagement with the output gear.

### RELATED APPLICATIONS

This application claims priority to German Application Ser. No. 102016221357.1, filed Oct. 28, 2016, the disclosure of which is hereby expressly incorporated by reference in its entirety.

### FIELD OF THE DISCLOSURE

The present disclosure relates to a wheel gear for a drive wheel of an agricultural vehicle, having a gear housing, a drive gear mounted on the gear housing, an output gear mounted on the gear housing, a first-stage intermediate gear pair with a first and a second first-stage intermediate gear, each having a first intermediate gear diameter and a second-stage intermediate gear pair with a first and a second second-stage intermediate gear, each having a second intermediate gear diameter.

### BACKGROUND

Wheel gears are known in the state of the art. They are used to convert relatively high speeds of a drive shaft for a vehicle wheel into a high torque on the vehicle wheel. The most common wheel gears are configured as planetary gears of the known kind and are characterized by a high flexibility in terms of speed and torque, but also by their favorable performance to structural volume ratio. The disadvantages are a high parts variety and cost.

Other solutions, for example, such as single-stage gears with a torque division are likewise known in the art. In this case, a drive train is divided by an intermediate gear pair into two parallel drive trains, wherein each intermediate gear is simultaneously directly in engagement with a drive gear and an output gear. Although relatively large torques comparable with planetary gears can be achieved in this way, gear configurations of this kind are, however, susceptible to damage on the participating gears, particularly on the relatively large output gear, due to the structurally based single-stage high transmission rate.

A need therefore exists for a gear wheel which has a smaller parts variety compared with planetary gears and a relatively favorable performance and structural volume ratio, and also a lower susceptibility to damage.

### SUMMARY

In one embodiment of the present disclosure, a gear wheel is configured in such a manner that a first-stage intermediate gear pair is in engagement with a drive gear and a second intermediate gear pair is in engagement with an output gear, wherein a first intermediate gear of the first-stage intermediate gear pair and a first intermediate gear of the second-stage intermediate gear pair are arranged in a non-rotational manner to one another on a first intermediate gear shaft rotatably mounted on a gear housing, and wherein the second intermediate gear of the first-stage intermediate gear pair and the second intermediate gear of the second-stage intermediate gear pair are arranged in a non-rotational manner to one another on a second intermediate gear shaft rotatably mounted on the gear housing.

This embodiment represents an advantageous drive torque division on the drive side, wherein the torque transmission takes place in two parallel drive trains. The rotating forces acting from the drive gear on the intermediate gears and from there on the output gear during the meshing of the participating gears can thereby be halved. Through the arrangement of a first-stage and a second-stage intermediate gear pair, a two-stage gear arrangement is created which allows a two-stage transmission and therefore a smaller loading overall of the individual gears and, in particular, of the output gear. Through the configuration of a second transmission stage with intermediate gear pairs, a more compact arrangement of the drive gear, intermediate gears and the output gear can be achieved. Overall, on the one hand, the structural volume can be kept favorably low and, on the other hand, the susceptibility to damage can be reduced. The arrangement of two transmission stages and also the torque division mean that high forces and therefore also high loads can be received overall, which lie within the power range of planetary gears.

The first intermediate gear diameter is greater than the second intermediate gear diameter, wherein the drive gear and the output gear overlap in the radial direction. A configuration of this kind produces a highly compact design, as the drive gear in particular also overlaps the periphery of the output gear and the distance between a drive shaft of the drive gear and an output shaft of the output gear can be reduced overall.

In a further embodiment, the first-stage intermediate gear pair and the second-stage intermediate gear pair exhibit different gear modules. This means that the toothing on the drive side may be selected to differ from the toothing on the output side, so that the loading limits can be increased or optimized overall and a greater variability overall in respect of performance characteristics and susceptibility to damage created.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 shows a schematic cross-sectional view of a wheel gear,

FIG. 2 shows a schematic perspective view of a gear arrangement of the wheel gear in FIG. 1 from a drive-side view,

FIG. 3 shows a schematic view of the gear arrangement from FIG. 2 from the side,

FIG. 4 shows a schematic view of the gear arrangement from FIG. 2 from below,

FIG. 5 shows a schematic side view of the gear wheel arrangement from FIG. 2 from the drive-side view, and

FIG. 6 shows a schematic side view of the gear wheel arrangement from FIG. 1 from the output-side view.

### DETAILED DESCRIPTION

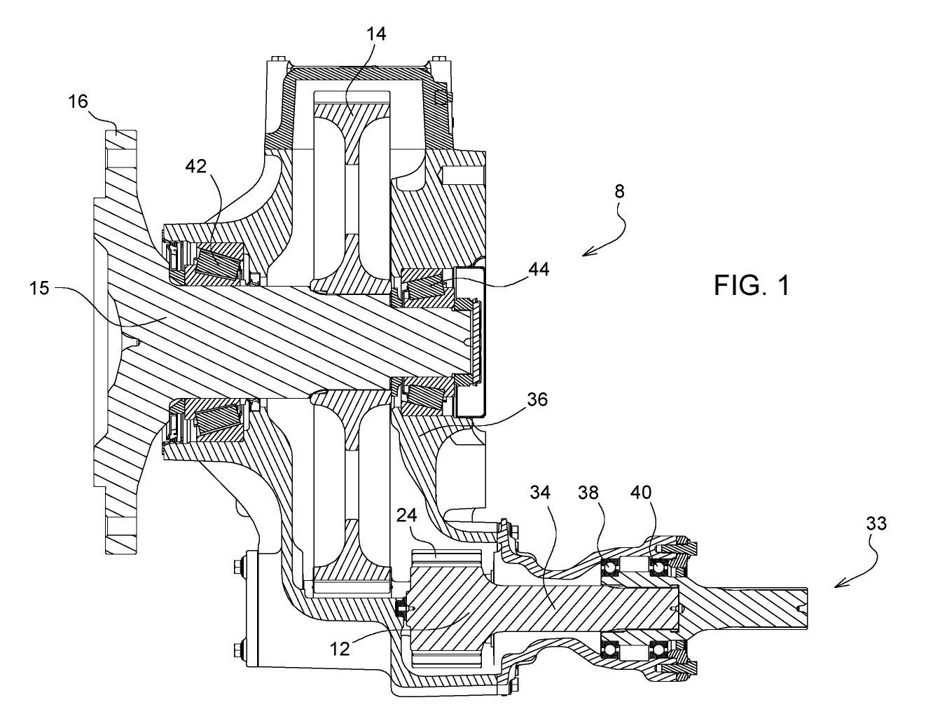

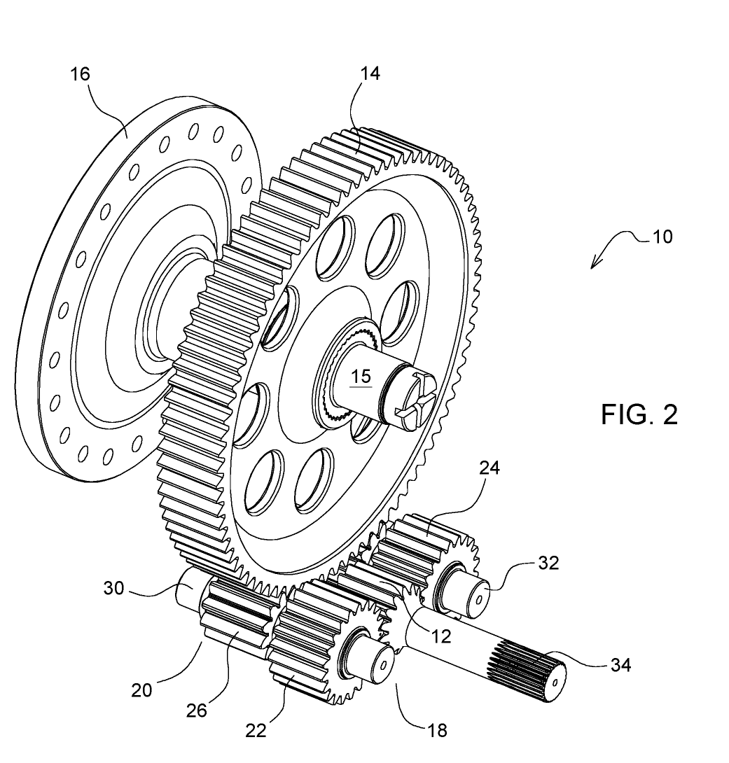

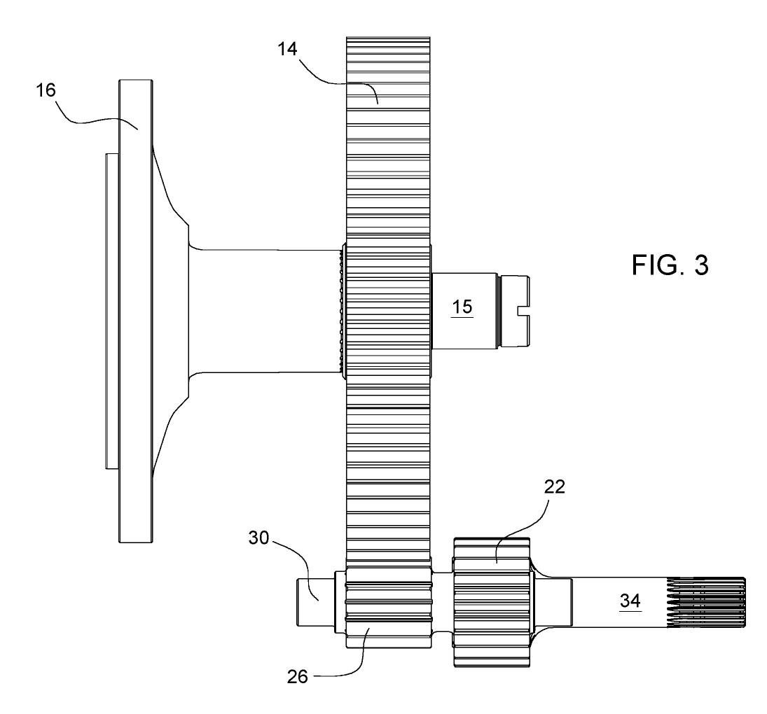

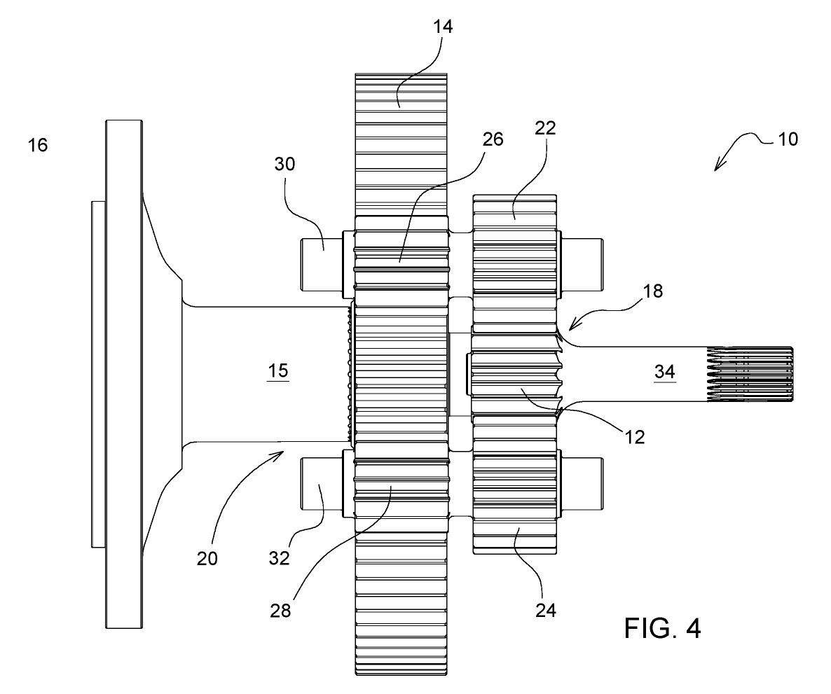

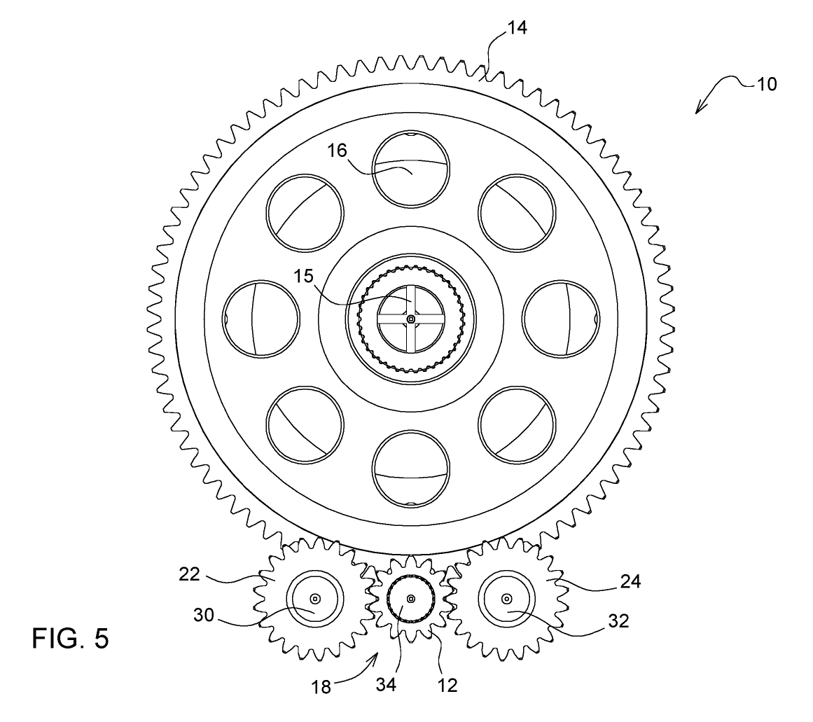

A wheel gear 8 depicted in FIG. 1 shows a gear arrangement 10 which is depicted in greater detail in FIGS. 2 to 6. The gear arrangement 10 includes a drive gear 12, an output gear 14 and a wheel flange 16 connected via an output shaft 15 to the output gear 14. Between the drive gear 12 and the output gear 14 is arranged a first-stage intermediate gear pair 18 and a second-stage intermediate gear pair 20, wherein the first-stage intermediate gear pair 18 represents a first transmission stage along with the drive gear 12 and the second-stage intermediate gear pair 20 represents a second transmission stage along with the output gear 14.

The first-stage intermediate gear pair 18 includes a first and second intermediate gear 22, 24 meshed with the drive gear 12, wherein the first and second intermediate gear 22, 24 are arranged on opposite sides of the drive gear 12. The second-stage intermediate gear pair 20 includes a first and second intermediate gear 26, 28 meshing with the output gear 14. The first intermediate gear 22 of the first-stage intermediate gear pair 18 and the first intermediate gear 26 of the second-stage intermediate gear pair 20 are arranged non-rotationally in respect of one another on a common first intermediate gear shaft 30. The second intermediate gear 24 of the first-stage intermediate gear pair 18 and the second intermediate gear 28 of the second-stage intermediate gear pair 20 are arranged non-rotationally to one another on a common second intermediate gear shaft 32.

The drive gear 12 is arranged on a drive shaft 34 driven by a drive train 33 of a vehicle (not shown), wherein in the exemplary embodiment shown, the drive gear 12 and the drive shaft 34 are integrally configured. Through the arrangement of intermediate gear pairs 18, 20, each with two intermediate gears 22, 24 and 26, 28, there is a torque division or a power split of the drive torque on the part of the drive train 33 or the drive shaft 34, which results in a division of the rotating forces and torques acting on the participating gears 12, 14, 22, 24, 26, 28 of the wheel gear 8.

As shown in FIG. 1, the wheel gear 8 includes a gear housing 36 and also bearing points with a shaft bearing 38, 40 for the drive shaft 12 and bearing points with the shaft bearing 42, 44 for the output shaft 15. Further bearing points (not shown) are provided for the intermediate gear shafts 30, 32 of the intermediate gear pairs 18, 20.

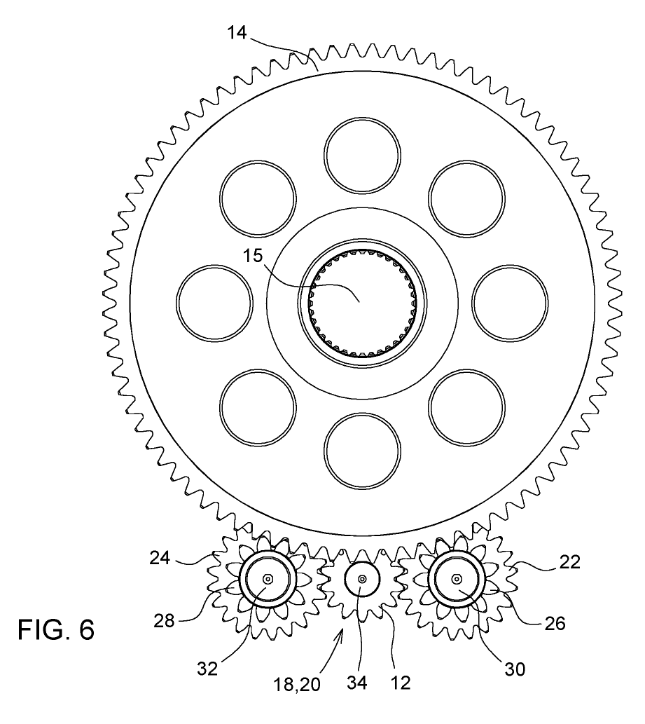

As can be seen in FIGS. 2 to 6, the drive gear 12 is arranged in the middle between the two first-stage intermediate gears 22, 24. An advantage compared with a one-stage embodiment of a gear arrangement with only one intermediate gear pair is that in this case, with the two-stage intermediate gear arrangement, the first-stage intermediate gear pair 18 is arranged axially in front of the output gear 14. The intermediate gears 22, 24 of the first-stage intermediate gear pair 18 may therefore exhibit greater diameters than the intermediate gears 26, 28 of the second-stage intermediate gear pair 20. In addition, an overlapping of the drive gear 12 with the output gear 14 is thereby made possible, wherein an overall transmission in two stages with the two different intermediate gear pairs 18, 20 is achieved. The overlapping ensures a maximally compact design of the gear arrangement 10, so that the drive shaft 34 and the output shaft 15 are arranged as closely as possible to one another. It is further possible for the intermediate gears 22, 24 and the drive gear 12 to have a gear module which is different from a gear module of the intermediate gears 26, 28 and the output gear 14, as can be seen in particular in FIG. 6.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A wheel gear for a drive wheel of an agricultural vehicle, comprising:
a gear housing;
a drive gear mounted on the gear housing;
an output gear mounted on the gear housing;
a first-stage intermediate gear pair comprising a first first-stage intermediate gear and a second first-stage intermediate gear, where each comprises a first intermediate gear diameter, and
a second-stage intermediate gear pair comprising a first second-stage intermediate gear and a second second-stage intermediate gear, where each comprises a second intermediate gear diameter,
wherein, the first-stage intermediate gear pair is in engagement with the drive gear and the second intermediate gear pair is in engagement with the output gear,
wherein the first intermediate gear of the first-stage intermediate gear pair and the first intermediate gear of the second-stage intermediate gear pair are arranged in a non-rotational manner to one another on a first intermediate gear shaft rotatably mounted on the gear housing,
wherein the second intermediate gear of the first-stage intermediate gear pair and the second intermediate gear of the second-stage intermediate gear pair are arranged in a non-rotational manner to one another on a second intermediate gear shaft rotatably mounted on the gear housing.

2. The wheel gear of claim 1, wherein the first intermediate gear diameter is greater than the second intermediate gear diameter.

3. The wheel gear of claim 2, wherein the drive gear and the output gear overlap in a radial direction.

4. The wheel gear of claim 1, wherein the first-stage intermediate gear pair and the second-stage intermediate gear pair comprise different gear modules.
